(19) United States
(12) Patent Application Publication
(10) Pub. No.: US 2005/0188026 A1
(43) Pub. Date: Aug. 25, 2005

(54) Email distribution system and method

(76) Inventors: David M. Hilbert, Palo Alto, CA (US); Jonathan Trevor, Santa Clara, CA (US)

Correspondence Address: FLIESLER MEYER, LLP, FOUR EMBARCADERO CENTER, SUITE 400, SAN FRANCISCO, CA, 94111, US

(21) Appl. No.: 10/777,571

(22) Filed: Feb. 11, 2004

(51) Int. Cl. G06F 15/16

(52) U.S. Cl. 709/206

(57) ABSTRACT

Embodiments of the present invention include systems, methods, and computer readable media for processing electronic mail attachments. Embodiments of the present invention intercept electronic mail messages containing attachments, and transmit the attachments to a file server. A message parser removes the file attachments from the messages and inserts hypertext links or executables directing the recipient to the copy of the attachment stored on the file server.

### FIELD OF THE INVENTION

The present application relates generally to systems and methods for transmitting electronic mail messages and specifically to methods for transmitting files attached to mail messages.

### BACKGROUND OF THE INVENTION

During the past five years electronic mail systems have become the preferred media for written communications. The ease of use, high speed of delivery, relative ubiquitousness, and low resource demands provided by electronic mail programs have made them a mainstay of personal and professional communications during a relatively short period of time.

However, current electronic mail systems are not without limitations. Many rely upon older protocols for sending and receiving electronic messages, such as Point of Presence or Simple Message Transfer Protocol. These protocols, while very effective, are not well suited for handling large file attachments. Many Internet Service Providers (ISPs) and corporate mail servers place strict limitations on the size of outgoing and incoming mail attachments. Additionally, users may access their electronic messages from machines with slower connections.

As commonly used files such as written documents, spreadsheets, and presentations have grown larger, and digital photos and videos have become more commonplace, these restrictions have complicated the process of sending files to friends, relatives, coworkers etc. Users can employ compression utilities to reduce the size of sent messages or to split file attachments across multiple messages. However, this solution is time consuming and obligates the recipient to reconstitute the original attachment from several messages. Additionally, a user with a low bandwidth connection will still be forced to download a large file attachment when receiving the message, regardless of the connection that he is currently using.

Alternately, users can upload larger files to remote file servers and provide the recipients with information necessary to access the file servers. However, this solution is time consuming and greatly reduces the convenience that makes email an effective communications tool.

What is needed is a solution that allows users to easily and transparently provide access to file attachments while minimizing bandwidth demands.

### SUMMARY OF THE INVENTION

Embodiments of the present invention include systems, methods, and computer readable media for processing electronic mail attachments. Embodiments of the present invention intercept electronic mail messages containing attachments and transmit the attachments to a file server. A message parser removes the file attachments from the messages and inserts hypertext links, executable files, or data files directing the recipient to the copy of the attachment stored on the file server, either of their own accord or with the assistance of an application on the user system.

The message parser refers to predetermined user preferences and separates the attachments from messages. Messages can be filtered according to the identity of the recipient, the type of file sent, the recipient of the file, the domain of the recipient, the size of the file sent, or any other characteristics. Alternately, attachments can be separated at the direct request of a sender. The attachments are stored on a file server selected by the user or a system administrator. Embodiments of the invention can reside on a sending user's system, a proxy server, an outgoing mail server, an incoming mail server, a recipient machine, or any other system present in the transmission path of the sent message.

### BRIEF DESCRIPTION OF THE DRAWINGS

FIG. 1 is block diagram illustrating an overview of the transmission of an electronic mail message according to one embodiment of the present invention.

FIG. 2 is a block diagram illustrating one embodiment of modules that perform the functions of the present invention.

FIG. 3 is a block diagram illustrating an overview of an electronic mail server which separates attachments from received electronic mail messages according to one embodiment of the present invention.

FIG. 4 is a block diagram illustrating one embodiment of a configuration file for a user of an electronic mail system.

FIG. 5 is a flow chart illustrating a process for receiving and transmitting electronic mail messages.

FIG. 6 is a flow chart illustrating a process for modifying an electronic mail message according to configured preferences.

### DETAILED DESCRIPTION

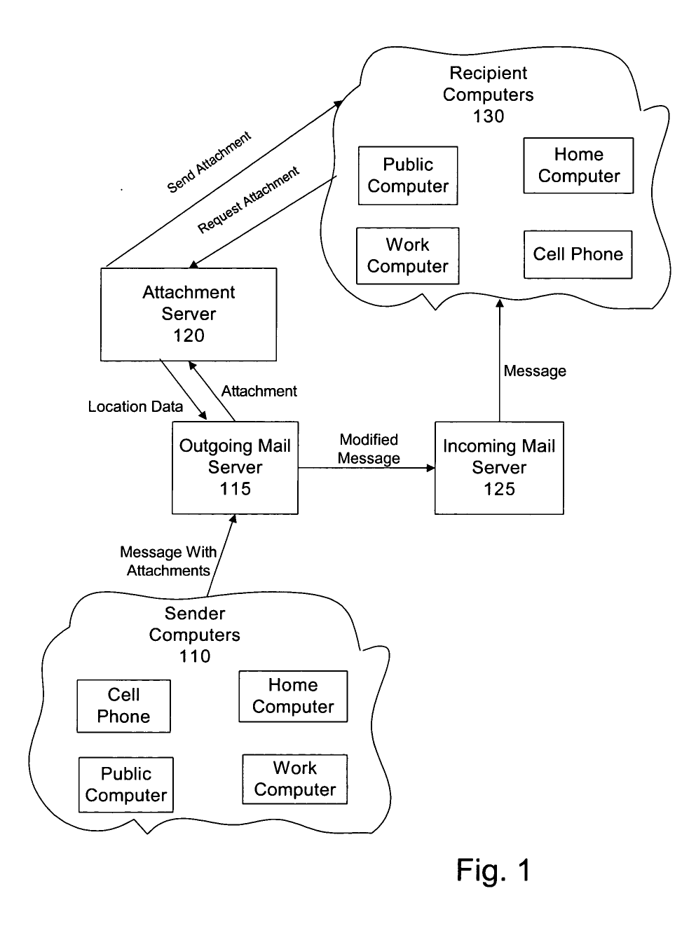

The present invention provides for the separation of file attachments from electronic mail messages. FIG. 1 is block diagram illustrating an overview of the transmission of an electronic mail message according to one embodiment of the present invention. A sender computer 110 transmits an electronic mail message with a file attachment to an outgoing mail server 115. In one embodiment the sender computer 110 is a user machine such as a public personal computer, a home computer, a work computer, or a data enabled cell phone from which the user composes the outgoing mail message. In an alternate embodiment, the sender computer 110 is an Internet host which generates a web interface for remote users to compose email messages.

The outgoing mail server 115 is a server used by an ISP or enterprise entity to transmit electronic mail messages. The outgoing mail server 115 receives the message and attachment from the sender computer 110. The outgoing mail server 115 separates the attachments from the messages and transfers them to an attachment server 120. The outgoing mail server may perform separation according to predetermined criteria or an explicit request from the user. A client on the user's system can accept a separation request, either provided beforehand or at the time of sending. An API on the outgoing mail server can be configured to accept the separation request.

The attachment server 120 is a file server which is enabled to receive files from the outgoing mail server 115 and process file transfer requests from message recipients. In one embodiment the attachment server 120 is also configured to perform transduction of file attachments. The attachment server can perform transduction upon receiving the file, or when the recipient attempts to download the file. The attachment server 120 can generate a low bandwidth version of a file for ease of access. Additionally, the attachment server 120 can modify attachments stored in less accessible file formats to more commonly used formats for ease of viewing, transmit, stream the file to the recipient, or translate any text in the file.

The outgoing mail server 115, after transmitting the attachments, embeds links or executable files in the message that are configured to enable retrieval of the file. The links are preferably hypertext links pointing towards a location of the file. The executables are programs configured to contact the attachment server and retrieve the files. The outgoing mail server 115 may also add tokens or some other security mechanism to the message to ensure that only the recipient can access the attachments stored on the attachment server 120 or apply other security mechanisms or methods of validation. The outgoing mail server 115 then transfers the modified message to the incoming mail server 125. While in the present embodiment, the act of separating the attachment and embedding the links or executables in the message is performed by the outgoing mail server, in alternate embodiments, it can be performed by the sender computer 110, the incoming mail server 125, or a proxy server.

The incoming mail server 125 is configured to store messages for retrieval by the recipient computer 130. The incoming mail server 125 can use Point of Presence(POP) protocols, Internet Mail Access Protocol or any other appropriate protocol for electronic mail transfer. In one embodiment, the recipient computer 130 is a public personal computer, a home computer, a work computer, or a data enabled cell phone from which users can retrieve messages, but like the sender computer 110 can also be an Internet server that generates a web interface for remote use.

When a user of the recipient computer 130, attempts to access his mail, the recipient computer 130 sends a retrieval request to the incoming mail server 125. The incoming mail server 125 transfers the modified message to the recipient computer 130. The user of the recipient computer 130, upon opening the message selects one of the embedded links or executables. This causes the recipient computer 130 to send a retrieval request to the attachment server 120. This request may include security credentials necessary to retrieve the file attachment, such as an authorized email address, a security certificate, or a password. Additional criteria may be used such as biometric data, a smart card, or any other identifier.

Validation of the additional security information may be performed by the executable, which then notifies the attachment server that the recipient has been validated or to simply pass along a request after validating the user. This would entail the executable prompting the recipient for validation information. Alternately, the validation can be performed by the server itself, which prompts the user for a password, email address, or other identifier. Additionally, the outgoing mail server may embed a data file in the message storing information about the location of the attachment and the information necessary to retrieve the attachment. The data file can be utilized by an application stored on the recipient's computer that uses the information stored in the data file to retrieve the attachment. The application can validate the user itself and submit a request to the attachment server, or pass the received validation information to the attachment server.

In some embodiments, the information necessary to securely retrieve the attachment is included in the link, executable, or data file itself. The link can include information such as a password or identifier that would be transmitted to the attachment server when the link is utilized by a browser. Alternately, the link can include an unusual or not easily reproducible location. In the case of an executable, the executable would have validation information such as a password or identifier installed within it, that would automatically be submitted to the attachment server.

The attachment server then transfers the file attachments to the recipient computer 130. If the attachment server 120 is able to perform transduction on the attachment, upon receiving the retrieval request the attachment server 120 can provide the user with a list of options, one being the unmodified version of the file, another being the modified version of the file. Modifications to the file can include compression of the file, changing the file to a more bandwidth efficient or accessible format, reducing the size or resolution of images, translation of any text in the file, and streaming of media files.

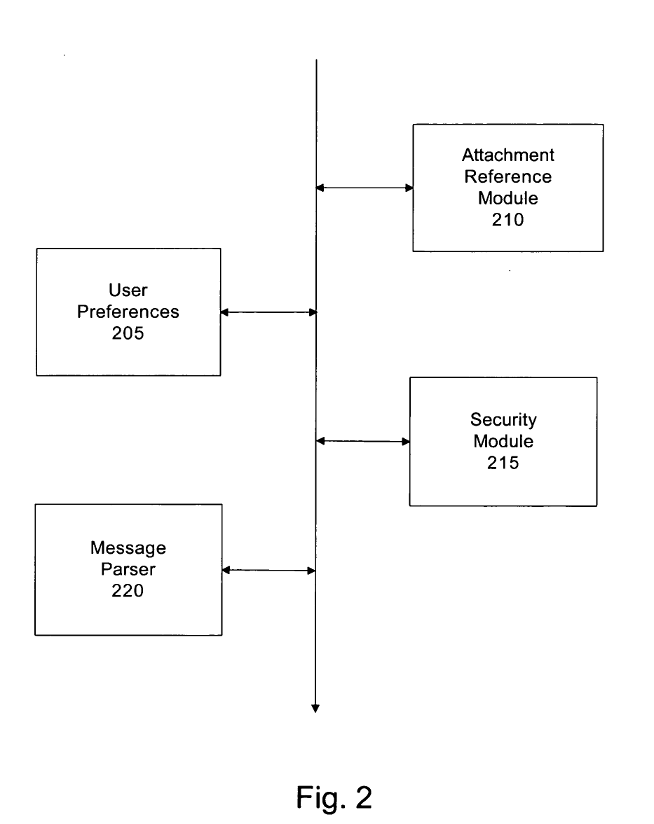

FIG. 2 is a block diagram illustrating one embodiment of modules that perform the functions of the present invention. These modules can be software, firmware, hardware, or any combination thereof. These modules can reside in an end-user machine, an outgoing mail server, a proxy server, or any other location where their functionality can be employed. While in the present embodiment, the modules reside on the outgoing mail server 115, in alternate embodiments, the modules can reside on the sender computer 110, the outgoing mail server 115, the incoming mail server 125, a proxy server, or any other system so equipped.

A user preferences file 205 stores attachment transmission preferences for multiple users. These preferences are sorted by user and include but are not limited to: minimum file sizes for separation of attachments, file types that are always/sometimes/never separated from messages, security restrictions to associate with messages, storage location preferences, and recipient preferences.

A message parser 220 is configured to receive messages with attachments, remove and transfer file attachments, and insert links, data files, and executables. The message parser 220 analyzes the message and according to the rules listed in the user preferences determines whether and how the attachments should be removed. The message parser 220 then transmits any separated attachments to a remote file server. An attachment reference module 210 detects the transmission of the file to the file server and provides links corresponding to the location or executables configured to retrieve the attachment. In alternate embodiments, the link, executable, or data file is generated by the attachment server 120 and is returned to the attachment reference module 210. In yet another embodiment, the executable or data file is generated by the attachment reference module but configured with an address provided by the attachment server. The message parser 220 retrieves the links, executables, and data files and embeds them in the message. In one embodiment, when a message includes multiple attachments, the message parser 220 may insert a link, executable, or data file directed towards a location storing the multiple attachments.

A security module 215 is configured to control security protections for separated file attachments. The security module 215 installs tokens or other identifiers in the message that enable the recipient of the message to retrieve files from the remote server. Additionally, the security module 215 can contact the attachment server and instruct it to store the attachment in a location corresponding to complex and hard to reproduce URL, or to require credentials such as a security certificate, an authorized mail address, or a password before allowing access to the attachment.

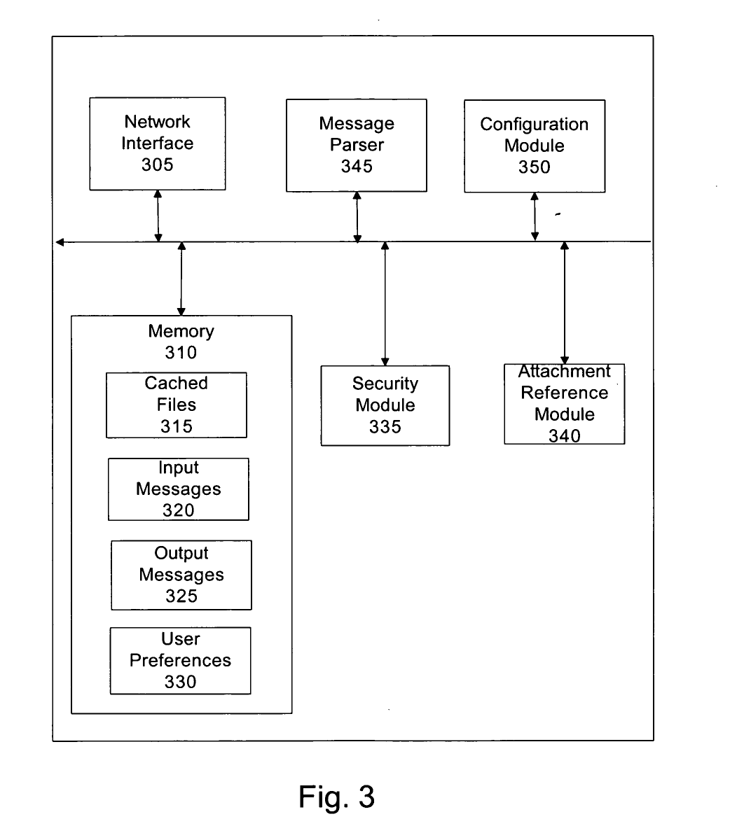

FIG. 3 is a block diagram illustrating an overview of an outgoing mail server 115 which separates attachments from received electronic mail messages according to one embodiment of the present invention. A network interface 305 transfers data between the outgoing mail server 115 and the sender computer, attachment server 120, and incoming mail server 125. The network interface 305 can be an Ethernet, WiFi, or T1 connection or any other connection which may be appropriate.

A memory 310 stores modifiable data for use by the control modules 335, 340, 345, 350. This includes a collection of cached files 315. The cached files 315 include attachments that have been removed from sent messages, but not yet transmitted to the incoming mail server 125.

The memory 310 also includes input messages 320. When messages are first received by the outgoing mail server 115 from the sender computer 110, they are stored with the input messages 325. After the messages have been modified by the control modules 335, 340, 345, 350, they are stored as output messages 325.

The memory 310 also includes a user preferences file 330 that stores attachment transmission preferences for multiple users. These preferences are associated with users and include but are not limited to: minimum file sizes for separation of attachments, file types that are always/sometimes/never separated from messages, security restrictions to associate with messages, storage location preferences, and recipient preferences.

A message parser 345 is configured to access messages stored in the input messages 320, remove and transfer file attachments, and insert links, data files, and executables. The message parser 345 analyzes the message and according to the rules listed in the user preferences 330 determines whether and how the attachments should be removed. The message parser 345 then stores the message in the output messages 325. An attachment reference module 340 detects the transmission of the file to the file server and generates links, data files, or executables associated with the location. In alternate embodiments, the link is generated by the attachment server 120 and is returned to the attachment reference module 340. In yet another embodiment, the executable or data file is generated by the attachment reference module, but is configured with an address provided by the attachment server. The message parser 345 retrieves the links and embeds them in the message. In one embodiment, when a message includes multiple attachments, the message parser 345 may insert a link to a directory storing the multiple attachments.

A security module 335 is configured to embed security protections in the message. The security module 335 installs tokens or other identifiers in the message that enable the recipient of the message to retrieve files from the remote server. Additionally, the security module 335 can contact the attachment server and instruct it to store the attachment in a location corresponding to complex and hard to reproduce URL, or to require credentials such as a security certificate, an authorized mail address, or a password before allowing access to the attachment.

A configuration module 350 is configured to modify the user preferences 330 in response to outside input. The configuration module 350 generates a user interface which allows an individual user or system administrator to modify the rules that are used to parse and modify messages.

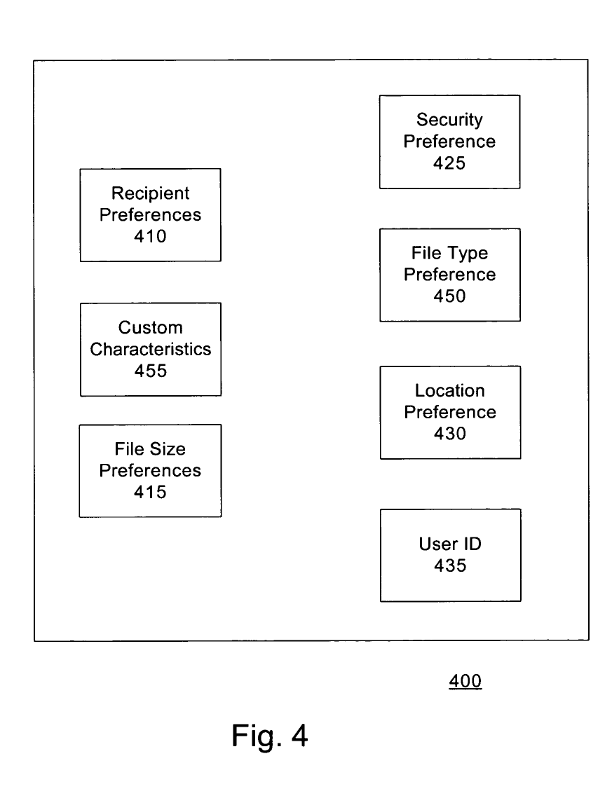

FIG. 4 is a block diagram illustrating one embodiment of a configuration file 400 for an electronic mail server. In one embodiment, this configuration file is stored in the user preferences 330 of FIG. 3. The configuration file includes a user ID 435 indicating the email address or other identifier associated with the listed preferences. This ID 435 is used by a message parser to determine which set of preferences to apply to a message.

The configuration file 400 also includes recipient preferences 410. These preferences list those users for whom attachments should be separated. For example, if a recipient accessed his mail through a high speed connection and an incoming mail server without a maximum message size, the recipient preferences could indicate that messages sent to the recipient should be unaltered. The recipient preferences 410 can be configured for groups of users or entire domains. For example, all users in a preselected group or having a preselected email address domain could always have their messages modified. The configuration file also includes file size preferences 415. These preferences include a minimum file size necessary for an attachment to be separated from a message. Additionally, the configuration file 400 lists file type preferences 450. These preferences include instructions for which file types, when presented as attachments should be separated from the connected message. The configuration file 400 also includes custom characteristics 455 which include attachment management criteria specified by a user. These custom characteristics 455 can include the employment of mechanisms such as compression or transduction for large file attachments.

The configuration file 400 also includes security preferences 425 and location preferences 430. The location preferences 430 indicate preferred servers for storage of separated attachments. The security preferences indicate the levels and mechanism for insuring secure access to the separated files. For example, the security preferences 425 can indicate that a recipient address or an authorized user will be required to access the mail attachment, or specify that a destination URL which is difficult to reproduce independently should be generated by the attachment reference module or attachment server.

The varying categories in the configuration file 400 can be cross-linked. Thus the configuration file can indicate that messages having attachment larger than 3 MB should be parsed only when sent to a particular recipient. Alternately, the cross-linked preferences could indicate that all Microsoft Excel spreadsheets should be stored on a particular file server.

In one embodiment, the configuration file 400 also includes transduction preferences for separated attachments. In an alternate embodiment, the transduction preferences are controlled by the attachment server 120.

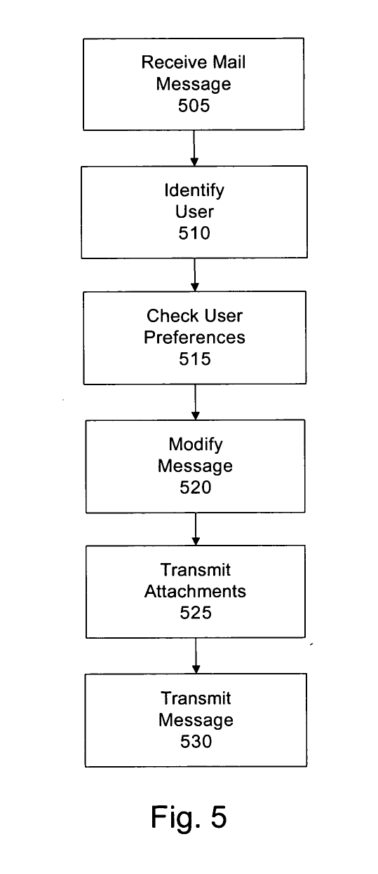

FIG. 5 is a flow chart illustrating a process for receiving and transmitting electronic mail messages. While in the present embodiment, this process is performed by the outgoing mail server 115, in alternate embodiments, the process can be performed by the sender computer 110, the outgoing mail server 115, the incoming mail server 125, a proxy server, or any other system so equipped.

The process begins with the outgoing mail server 115 receiving the message from the sender computer 110. The message parser 345 then identifies 510 the user who sent the message. This step may involve checking a sender address field of the message or determining an originating Internet Protocol address for the message. The message parser 345 then checks 515 the user preference file 400 associated with the sender of the message to determine the message parsing preferences associated with the sender of the message. Alternately, the outgoing mail server may perform separation according to an explicit request from the user. A client on the user's system can accept a separation request, either provided beforehand or at the time of sending. An API on the outgoing mail server can be configured to accept the separation request. If the outgoing mail server 115 is unable to identify a user associated with the message, the outgoing mail server is configured to extract a generic profile for parsing incoming messages.

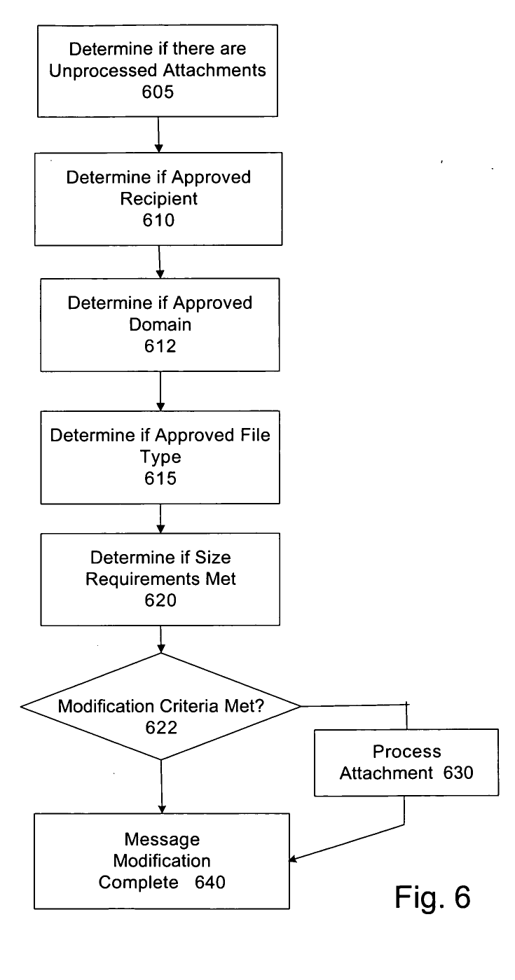

The message parser 345 then modifies the message according to the rules listed in the user's preference file 400. In an alternate embodiment, the message parser 345 checks rules embedded in the message itself in order to make modification decisions or receives directions from the sender computer via an API call. The message may include whether it should be modified, when it should be modified, and whether server side transduction should be performed. The message parser utilizes the attachment reference module 340 and the security module 345 to generate the links, executables, and data files and install security measures in association with the message or to direct the attachment server to do so. The process is illustrated in greater detail with respect to FIG. 6.

The message parser 345 then transmits 525 any separated attachments to the attachment server 120. If the rules listed in the user's preference file 400 do not indicate that attachments should be separated, or if the message does not include attachments, no attachments are sent. The message parser 345 then transmits 530 the message to the incoming mail server 125.

FIG. 6 is a flow chart illustrating a process 600 for modifying an electronic mail message according to configured preferences. While in the present embodiment, this process is performed by the outgoing mail server 115, in alternate embodiments, the process can be performed by the sender computer 110, the outgoing mail server 115, the incoming mail server 125, a proxy server, or any other system so equipped. Also, while in the present embodiment, the decision to separate the attachment is performed according to predetermined user criteria, the outgoing mail server may perform separation according to an explicit request from the user. A client on the user's system can accept a separation request, either provided beforehand or at the time of sending.

The process begins with the message parser 345 determining 605 whether the message includes any unprocessed attachments. The message parser 345 then refers to the user's configuration file 400 to determine 610 whether attachments should be processed for the present recipient mail address. The message parser then checks the domain of the recipient and the configuration file 400 to determine whether messages to the destination domain should be modified. The message parser then checks the configuration file 400 to determine 615 whether the file type in question should be separated. The message parser then checks the configuration file 400 to determine 625 whether the size of the attachment indicates that it should be separated.

The message parser then checks the results of steps 610 through 620 to determine whether the file should be separated. In one embodiment, the configuration file 400 includes a Boolean set of rules indicating combinations of tests, that if passed, indicate that the attachment should be processed. For example, the preferences might indicate that if the message is sent to an approved recipient and is larger than the minimum size, that it should be sent. In an alternate embodiment, the configuration file includes a set of weights to apply to each criterion and a threshold value that if surpassed, indicates that the attachment should be separated.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

1. A method for processing electronic mail messages, the method comprising:
accepting an electronic mail message, the electronic mail message including a file attachment;
removing the file attachment from the electronic mail message;
storing the file attachment in an attachment location; and
inserting a hyperlink in the message, the hyperlink associated with the attachment location, and configured to cause the submission of validation information to a server storing the attachment.

2. The method of claim 1, wherein the hyperlink is configured such that accessing the hyperlink will cause the submission of a password to the server storing the attachment.

3. The method of claim 1, wherein the attachment location is a location on a web server and the hyperlink includes the address of the web server.

4. The method of claim 1, further comprising generating a low bandwidth version of the file attachment upon request.

5. A method for processing electronic mail messages, the method comprising:
accepting an electronic mail message, the electronic mail message including a file attachment;
determining whether to remove the file attachment;
in response to a positive determination, storing the file attachment in an attachment location; and
inserting in the message, an executable configured to retrieve the attachment from the attachment location.

6. The method of claim 5, wherein the executable is configured to prompt a recipient for validation information.

7. The method of claim 5, wherein the executable includes validation information which enables the retrieval of the attachment from the attachment location.

8. The method of claim 5, further comprising generating a low bandwidth version of the file attachment upon request.

9. The method of claim 5, further comprising converting the file to a commonly usable format.

10. The method of claim 5, wherein determining whether to remove the file attachment comprises determining an identity of a recipient of the electronic mail message.

11. The method of claim 5, wherein determining whether to remove the file attachment comprises determining a domain of a recipient email address.

12. A computer program product, stored on a computer readable medium, and including computer executable instructions for controlling a processor to process electronic mail messages, the instructions comprising computer code for:
accepting an electronic mail message, the electronic mail message including a file attachment;
determining whether to remove the file attachment according to previously determined criteria; and
in response to a positive determination, storing the file attachment in an attachment location.

13. The computer program product of claim 12, further comprising inserting a hyperlink in the message, the hyperlink associated with the attachment location.

14. The computer program product of claim 12, further comprising inserting a data file in the message, the data file configured to enable retrieval of the attachment.

15. The computer program product of claim 12, further comprising storing a low bandwidth version of the file attachment.

16. The computer program product of claim 12, further comprising converting the file to streaming content.

17. The computer program product of claim 12, wherein determining whether to remove the file attachment comprises determining a domain of a recipient mail address.

18. The computer program product of claim 12, wherein determining whether to remove the file attachment comprises determining a type of the file attachment.

19. A system for processing electronic mail messages, the system comprising: a message parser configured to:
accept an electronic mail message, the electronic mail message including a file attachment;
determine whether to remove the file attachment;
in response to a positive determination, store the file attachment in an attachment location; and
insert an attachment reference associated with the attachment location and configured to cause the submission of validation information to a server storing the attachment location; and
a attachment reference module configured to manage the generation of the hyperlink.

20. The system of claim 19 wherein the attachment reference is a hyperlink.

21. The system of claim 19, wherein determining whether to remove the file attachment comprises determining a size of the file attachment.

22. The system of claim 19, wherein determining whether to remove the file attachment comprises determining an identity of a sender of the electronic mail message.

23. The system of claim 19, wherein determining whether to remove the file attachment comprises determining a type of the file attachment.

24. The system of claim 19, wherein the attachment reference is an executable.

25. The system of claim 24, wherein the executable is configured to prompt a recipient for validation information and then submit the received validation information to the server storing the attachment location.

26. The system of claim 19, wherein the attachment is a media file and the system is further configured to stream the attachment to a recipient.

27. The system of claim 19, wherein the attachment is a document including text and the system is further configured to translate the text.

28. The system of claim 19, wherein the server storing the attachment prompts a recipient for validation information when the recipient attempts to retrieve the attachment.

29. The system of claim 19, wherein the attachment reference is a data file.

30. The system of claim 29, wherein the data file is configured to enable an application stored on a recipient computer to retrieve the attachment from the server storing the attachment.
